(19) United States
(12) Patent Application Publication
(10) Pub. No.: US 2008/0141541 A1
(43) Pub. Date: Jun. 19, 2008

(54) Power tool for completing yard work and process for making same

(76) Inventor: Edward Patrick Hurley, Sarasota, FL (US)

Correspondence Address: EDWARD P. HURLEY, 1214 WESTERN PINE CIRCLE, SARASOTA, FL, 34240, US

(21) Appl. No.: 12/009,483

(22) Filed: Jan. 19, 2008

Related U.S. Application Data
(63) Continuation-in-part of application No. 11/008,037, filed on Dec. 9, 2004, now abandoned.

(51) Int. Cl. A01D 34/00

(52) U.S. Cl. 30/276; 83/13

(57) ABSTRACT

A yard tool having a motor connected to a string trimmer for light lawn grooming purposes or other auxiliary yard tool attachments, each yard tool attachment having a separate shaft and handle that attach to the motor by a rotation and translation locks, the translation lock further having a three-way bayonet lock for one or more shaft button stops to lock into, the yard tool attachments having a series of longitudinal, lateral and vertical working planes that can be orientated along identical transport routes, a power control handle having an aperture for an index finger to compress the button stops to release the motor from the yard tool attachments, the power control handle having ribs that are slightly compressed onto the shaft and tracks for the button locks to glide through, the rotation lock maintains the string trimmer and tool attachments in a fixed orthogonal isometry.

### CROSS REFERENCE TO RELATED APPLICATIONS

This is a continuation in part of Ser. No. 11/008,037, filed on Dec. 9, 2004 and abandoned on 16 May 2007. The parties associated with the abandonment are the Inventor, Hurley ET AL, Mr. Edward F. Landrum of Art Unit 3724, the Examiner, and Mr. Boyer D. Ashley, the Supervisory Patent Examiner.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of yard maintenance and more specifically to a power tool for completing yard work and process for making same.

Yard work sometimes involves delays from long droughts that bring with it unexpected weeds or heavy rainfall that may generate faster and higher resistant shoot growth which can lead to grueling hard work. In order to keep up with the demands of home yard work, most operators groom their lawns with lightweight string trimmers, lawn trimmers which can help reduce labor costs when weather turns for the worse. Many lawn tools are equipped with different power sources to make storm or other related yard clean up a breeze for a diverse group of experienced, untested, healthy or ailing individuals. Having several power sources in a garage is good for having backup power, but the practice could lead to less security from garage clutter and high toxin counts vented into home dwellings.

Some motors are equipped with yard tool attachment quick links to address many environmental challenges. Unfortunately, most yard tool quick links are located near the midpoint of a shaft making it more difficult to fit operators to yard tools. For example, a number of horizontal string trimmers are allowed to be interchanged with vertical lawn edgers at a shaft midsection which could weaken yard tools. Furthermore, a yard tool midsection link method doesn't provide important control handle quick link alternatives which either leads to slower handle assembly maintenance issues or the process forces end users to perform yard care with potentially deficient control handles. One would expect yard tool quick links to produce distinctive shaft lengths out in the field. Surprisingly, some outdoor yard maintenance equipment may have tree pruning attachments with about the same tool length as hedge trimmer substitutes due mostly to an inadequate mid-linkage shaft problem. An imperfect shaft link will most likely translate to poor overall cutting measures, thus adding more strain to tools and operators. Finally, there are certain quick links that will allow metallic bladed instruments to be fastened in ninety degree orbital positions which could be unsafe. No matter what the surroundings, yard tools must be properly fitted with an efficient and clean burning motor, a structured shaft and an accurate handlebar system so that people, property, plants and pets are maintained in a safe environment. Therefore, a valuable safety factor to consider prior to yard care is to match yard tools with the most able-bodied attachment selections possible.

Popular D handles are known to yard equipment enthusiasts as an affordable means for maneuvering yard tools, but the grip orientation won't necessarily encourage an operator to maintain an industry standard hand grip. Regrettably, one-hundred and eighty degree lateral D grips describe a two-to-one combined hand position for vertical edging and horizontal trimming, respectively, without the best leverage or support possible. A one-hundred and eighty degree D grip openings only compounds home or commercial yard maintenance problems when other tool attachments are far from a garage while an existing quick link method is begging to be employed out in a yard for lawn edging purposes. Flawed control grips are further limited to providing the same horizontal grip for lawn trimming that can't be raised congruently with an asymmetrical edging plane. Some D handles are known to break because of having limited spokes which is costly and risky. Since D handles are imbalanced they are more likely to be left idle in certain work locations. Another concern with popular D handles is that they may not be replaced with more appropriate lateral bar arms or bull horn handle supports when a brush cutter blade is interchanged with a string trimmer head. It would appear from experience that complimentary handles would be a better fit on a supplementary shaft as opposed to potential trouble caused by universal D handles.

Having an ability to combine one or more lightweight power tool functions into a better controlled setting is significantly different than accomplishing specific one-on-one outdoor yard duties with individual lawn tool attachments. First of all, properly fitted lightweight lawn groomers encourage landscapers to get out and walk yard perimeters at a slighter faster pace for important aerobic exercise. Secondly, regular lawn trimming and edging with fitted power tools improves conditioning for accomplishing heavy-duty work tasks. For example, heavy-duty yard work may periodically consist of lawn edging, brushcutting, tree work, and hedge trimming which can be difficult to achieve when light-duty yard grooming cycles are skipped. Heavy-duty yard maintenance is known to intermingle well with light-duty yard work because different muscle groups can be exercised at a slower rate and at different times. As a result, it would be of great value to have an ability to combine yard tool attachments in a safe manner.

String trimmers can come with a metallic lawn edger attachment which is expected to operate in a vertical tool framework. These metallic stick edger stand-ins may or may not consist of an exclusive quick link locking mechanism for non-orbital purposes. Stick edgers usually have many features including a wheel, a three-way cutting guard, rigid metallic blades and a transmission for slower blade speed and higher torque and a mud brush. A few of the disadvantages of stick edgers is that the wheel adds weight at the tool origin which make yard tools more difficult to carry or operate along sensitive vegetation beds. High resistance to the transmission can put strain on drive shafts causing them to bend. Consequently, facilitating a string trimmer as a lawn groomer will help some home owners alleviate some of the hard work metallic lawn edgers will bring. A different type of horizontal metallic bladed yard tool attachment specifically known as a brushcutter attachment requires a bar arm or special lateral control handle mounted to a longer shaft to keep sharp instruments mostly at ground level, further from an operator than usual hedge trimmers. It is vital to consider the time it takes to assemble handles when interchanging yard tools like the ones mentioned above. Moreover, many home owners are unaware of the advantages and disadvantages of using yard tool handles. In terms of brushcutter disadvantages, some arborists believe that horizontal chainsaw type blades should be banned and traded in for home heating oil because of the damage they can cause to trees and property. In view of that, home deed restrictions will always counterbalance sprawl of vegetation after plants begin to take over neighborhoods followed by fire damage to buildings. Besides, a tree pruner, with hopefully a longer shaft than a brushcutter, can also be attached to a main yard tool with a long pole type handle to help keep homes or wooded environments more open and cozy.

Yard tool pruning attachments are useful for cutting down smaller two to four inch diameter hanging limbs whereas it is always best to seek professional advice from tree trimming companies when larger tree limbs are hanging low next to the ground. Having said that, tree pruners can be used during stormy weather to clear off walks or be used to shape trees to make a yard look more attractive. Some of the disadvantages of pole saws are overcome by building longer storage racks in garages that are easy to get to, i.e., it is common to build pole saw racks above other tool racks making the pruner more challenging to get to. Another disadvantage with tree pruners is that they sometimes get pinched into limbs after the operator forgot to conduct a bottom limb short vertical cut followed by an upper intersecting cut. Tree pruners are less likely to snag on smaller limbs because of leverage and weight aspects of trees. Hence, pruning obstacles can be easily overcome by reacting to conditions set forth on main yard tool transport routes which affords more time and better observation for tree chores.

For economic reasons, it may be best to own yard tool attachments if rental alternatives involve more than a few work cycles per year. Yard tool attachments can cost as much to rent after three or four uses and are usually in short supply when needed most. A lighter-duty main yard tool like a string trimmer and its additional heavy-duty attachments could be a better alternative to draining a pocketbook with expensive rental fees. Thus, home owners and professional landscapers may appreciate an ergonomic, properly fitted lawn grooming tool and its attachment benefits to go along with unexpected events or periodic heavy-duty yard work.

Some effort has been made to address concerns with yard tools and auxiliary attachments. One such yard tool alternative comes from U.S. Pat. No. 6,591,595 B1 that orientates a heavy-duty brushcutter into vertical and horizontal working planes to remove small trees in confined areas around homes and buildings. This design may fatigue an operator when a grappler handle is held with one hand while the remaining hand holds onto the much heavier cutting machine. Furthermore, grappling independent handlebars may be dangerous on grounds slopes where yard tools are known to sometimes tip over when held improperly. The horizontal blade is likely to scalp frontal ground cover which could lead to a further pest and yard treatment problem. Scalping of grounds cover should be discouraged because the process also tends to draw debris back towards an operator or kick heavy machines into dangerous directions. Putting the rear tandem stability skids in front of the transport wheels would put less strain on the tool and end user from this invention.

The U.S. Pat. No. 6,006,434 relates to a plurality of yard tool attachments that are coupled in front of a pair of control handles. The main disadvantage of this invention is that yard tools like horizontal brushcutters, that normally require lateral bull horn handles to prevent power tool kickback towards an operator, are difficult to re-assemble onto tool shafts; especially when operators are in a hurry for weather related issues or when daily yard chores are coming to an end. The coupler of this invention splits the drive shaft which can add to material costs and apply potential stress to extra keyways. Furthermore, production lines and storage departments tend to be more efficient with less complicated shaft parts that run through machine processes more quickly. This invention permits horizontal brushcutter attachments to be fastened to a quick link in a vertical fashion or a vertical stick edger tool assembly to be quick linked to the motor in a horizontal framework which could be unsafe when metallic blades are rotating at high rpm.

U.S. Pat. No. 5,918,683 is a well equipped stick edger having a convenient wheel lift for heavy-duty lawn edging. Although this invention is thoughtful and creative when being fitted for heavy-duty yard use, the main disadvantage is that outdoor distributors of lawn tools line their store shelves more abundantly more high volume quick feed combination string trimmers edge and trim lawns. Who can blame home tool distributors for meeting demands for $50,000.00 home improvements or $49,999.00 four-wheel drive mowers when good tool attachment like U.S. Pat. No. 5,918,683 have to compete with lightweight combination trimmers and edges that sell themselves without much discussion. Therefore, the main disadvantage of U.S. Pat. No. 5,918,683 has to do with weight and costs constraints for owning additional heavy-duty yard tool attachments. U.S. Pat. No. 4,455,093 is a timer device for yard tool attachments. The main disadvantage of this invention is that the shut off key can hurry a yard operation and potentially cause accidents. Additionally, this invention is known to be operated when yard tools are in high demand, making owning power tool attachments a better value alternative than renting.

U.S. Pat. No. 6,041,463 reveals a handheld broom sweeper attached to a motor. The main disadvantage of this invention is that it is too heavy to lug around for daily yard grooming. Another disadvantage of the sweeper is that the rolling bristles are difficult and expensive to replace. Main yard tool string trimmer attachments typically have flexible string line filament that require more rigid support when meeting high resistance during rotary activities like vertical lawn edging and this invention appears to be impractical for supporting and stabilizing longer string line filament. Accordingly, the bristles are unable to act as cooling agents or shock absorbers for lawn edging with spools of string line filament. Furthermore, this invention high number of bristles are not effective for preventing mud from entering into string trimmer heads because the sweeper is mostly used to make contact with a grounds surface.

What is important to remember about yard work is that physical stamina is more likely to be built up when lightweight power tools and their heavy-duty counterparts are properly fitted to an operator. By adding affordable, more comfortable features to a main lawn power tool assembly, home and commercial operators are more suited to take care of unpredictable outdoor situations.

### BRIEF SUMMARY OF THE INVENTION

The primary object of the invention is to provide a yard tool with a motor.

Another object of the invention is to provide the motor with an upright position to prevent a fuel tank from leaking.

Another object of the invention is to provide the motor with an arm rest and tool lever.

A further object of the invention is to provide the motor with a power control handle.

Yet another object of the invention is to provide the power control handle with a harness clip mount that maintains a similar upright orientation with the motor.

Still yet another object of the invention is to provide the power control handle with tool attachment rotation and translation quick coupler locks.

Another object of the invention is to provide the power control handle with means to release tool attachments safely and quickly.

Another object of the invention is to provide the yard tool with a main tool attachment consisting of string trimmer head, a cutting guard, a shaft and a Y control handle.

A further object of the invention is to provide the string trimmer head with a lateral debris brush that is also used to stabilize rotating string line filament.

Yet another object of the invention is to provide the yard tool with a sweeper tool attachment consisting of a blower, a shaft and the Y control handle.

Still yet another object of the invention is to provide the yard tool with a edging tool attachment consisting of a metallic blade, a cutting guard, shaft a wheel and a V handle.

Another object of the invention is to provide the edging tool attachment with a dual button lock for a fixed vertical operating framework.

Another object of the invention is to provide the yard tool with a brush cutter tool attachment consisting of a metallic blade, a cutting guard, a shaft and a J handle or the like.

A further object of the invention is to provide the brush cutter tool attachment with a dual button lock for a fixed horizontal operating framework.

Yet another object of the invention is to provide the yard tool with a hedge trimming tool attachment consisting of a dual-metallic cutting blades, a shaft and the Y handle that acts as a guard.

Still yet another object of the invention is to provide the hedging trimming tool attachment with a button lock that limits plant shaping to two-hundred and seventy degrees axis rotation.

Another object of the invention is to provide the yard tool with a pruning tool attachment consisting of a metallic blade, a shaft and a two-way pole handle.

Another object of the invention is to provide the pruning tool attachment with a dual button lock to hold the motor downward more firmly.

A further object of the invention is to provide a debris brush that will stabilize and reduce wear to yard tools.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a power tool for completing yard work comprising: a power source, the power source having a motor, the motor having a fuel tank or the like, a string trimmer yard tool attachment, the string trimmer having a shaft, the string trimmer having a drive shaft, the string trimmer having a Y handle, the string trimmer having a lawn cutting guard that substantially aligns with a lawn surface at all times of operation, the string trimmer having a button stop that connects the shaft to a translation and rotation lock at the motor distal end, the button stop engages a three-way bayonet, the shaft having a longer or shorter shaft casing, the string trimmer having an orthogonal isometry yard tool operating framework, the operating framework having longitudinal, lateral and vertical tool working planes, the tool working planes having identical yard tool transport routes, the tool working planes aligning parallel to a transport route of the main yard tool, the horizontal tool plane pivotal motion is parallel to the yard tool transport route, a power control handle, the power control handle having a longitudinal grip, the power control handle mounts to the motor casing, the power control handle having an lower aperture, the lower aperture having means for an index finger to compress the button stop for releasing the shaft at the motor distal end, the power control handle having ribs, the ribs are slightly compressed onto the shaft, the power control handle having tracks, the translation and rotational locks strengthen the shaft, the translation button stop and bayonet rotation lock maintain the string trimmer in a set operating framework when the rotation lock is released, the power control handle having a translation lock, the power control handle having a shaft release button, the power control handle having the main rotational lock at a frontal end and the translation lock tucked away for safe keeping, the motor mounts within a motor casing, the motor casing having an arm rest, the shaft casing can be extended into the motor casing, the shaft casing extension protects a plurality of stowed shafts, the arm rest having a lever to lift yard tools, the arm rest having means to help stabilize lateral yard tool motion, the arm rest having means to help stabilize vertical yard tool motion, the arm rest having means to help stabilize longitudinal yard tool motion, the arm rest having means to lift the yard tool as the fuel tank empties, the arm rest having means for right or left forearm use, the arm rest having means to assist with twelve or more different hand-arm muscle exercises, the string trimmer head having a debris brush, the debris brush having means to stabilize the yard tool, the debris brush made up of fine bristles, the debris brush having means to strengthen rotating string line filament outer ring tips, the debris brush having means to cool rotating string line filament spools, the debris brush having means to be replaced when worn, the debris brush having means to be clean the string trimmer head when rotated, the shaft having either a single or a dual button stop connected at the shaft motor end, the shaft having means to connect to compress onto a plurality of yard tool attachments, the shaft having means to have a plurality of segment lengths, the tool working planes aligning parallel to a transport route of yard tool attachments, the ribs having means for suspending a power cable support, the ribs having means for suspending a power wire, the ribs having means for dynamic reduction, the wand having means to be raised by the arm lever, the Y handle having a horizontal working plane grip and left and right vertical working plane grips, the Y handle having means to congruently align with optimal horizontal and vertical working planes, the Y handle having a yoke, the yoke having means to switch in an opposite direction, the Y handle having a plurality of lateral grip holding positions, the drive shaft rotated on a three-dimensional longitudinal, vertical and lateral axis, the drive shaft translated on the working plane, the drive shaft having means to be driven on a center of rotational symmetry, the drive shaft having means to be directed on a center of gravity, the drive shaft having means to be driven on a transport route, the drive shaft having means to maintain idle speed on the transport route, the drive shaft having means to be driven at substantially equal load at wide open throttle with auxiliary yard tool attachments, the drive shaft having means to drive the yard tool attachments at the shaft yard work distal end, the drive shaft having means to be driven by the motor at an opposite distal end of the shaft, the string trimmer may or may not have a transmission at the yard work distal end, the lawn cutting guard having aerodynamic guides, the power control handle and lateral Y handle having substantial balance, the power control handle and Y handle having combined torque to rotate yard tools attachments, interchanging of yard tool attachments without the need of interchanging handles the shaft, interchanging of yard tool attachments without the need of interchanging tools on the shaft, an auxiliary blower yard tool attachment that is operated between wide or narrow air discharge, the blower having the Y handle or the like for quick wand working planes that are linked to the motor, the auxiliary blower having means for the arm rest to be worked as a wand, the wand helps to control airflow disturbances, the blower having a shaft, the blower having a drive shaft, the blower may or may not have a wheel having, the blower having about a six inch fan mounted within a blower guard, the blower having a button stop that connects the shaft to the translation and rotation lock at the motor distal end, the blower shaft having a longer or a shorter shaft casing, the blower having means for a downward split vortex to maneuver debris in a horizontal working plane while keeping it mostly at ground level, the blower having means to be stabilized by the longitudinal arm lever, an auxiliary lawn edger tool yard tool attachment that is substantially operated in a vertical working plane, the edger having a shaft, the edger having a drive shaft, the edger having a transmission that drives the hedge trimmer, the edger having a wheel or the like, the wheel having means to help stabilize the edger, the edger having a V handle or the like, the V handle having means to hold the edging tool working plane in vertical working plane at all times of operation, the edger having a vertical metallic blade, the edger having a vertical and horizontal metallic cutting guard that significantly aligns to a lawn surface with aerodynamic guides, the edger having a dual-button stop that connects the shaft to the translation and rotation lock at the motor distal end, the edger shaft having a longer or a shorter shaft casing, the edger having means to maintain a vertical working plane at all times of operation, the edger having means to be stabilized by the longitudinal arm lever, an auxiliary brushcutter yard tool attachment that substantially operated in a horizontal working plane, the brushcutter having a shaft, the brushcutter having a drive shaft, the brushcutter having a transmission to create more torque with slower tool speed, the brushcutter having a J or bull horn handle, the J handle having a pair of lateral and overhand grips, the lateral grip having means to leverage the brushcutter with a strong claw or thumb grip, the brushcutter having a horizontal metallic blade, the brushcutter having a horizontal and vertical metallic cutting guard that significantly aligns to a lawn surface with aerodynamic guides, the brushcutter having a dual button stop that couples into the translation lock at the motor distal end, the brushcutter shaft having a longer or shorter shaft casing, the brushcutter having means to maintain a horizontal working plane link to the motor, the brushcutter having means to be stabilized by the longitudinal arm lever, an auxiliary hedge trimmer yard tool attachment that substantially operates in a two-hundred seventy five degree longitudinal radius, the hedge trimmer having a shaft, the hedge trimmer having a drive shaft, the hedge trimmer having a transmission to create more torque with slower tool speed, the hedge trimmer having a Y handle, the hedge trimmer Y handle having three grips, the grips having means to sculpt plants into round or platonic patterns, the hedge trimmer having a dual metallic blade, the hedge trimmer having a three-hundred sixty five degree cutting and debris guard, the hedge trimmer Y handle provide a second three-hundred sixty degree cutting guard, the hedge trimmer having a dual button stop that couples into the translation lock at the motor distal end, the hedge trimmer shaft having a longer or shorter shaft casing, the hedge trimmer having means to maintain the same power control handle grip for a third three-hundred sixty degree cutting guard, the hedge trimmer having means to be stabilized by the longitudinal arm lever, an auxiliary pole saw yard tool attachment that substantially operated in a vertical working plane, the pole saw having a shaft, the pole saw having a drive shaft, the pole saw having a pole handle, the pole saw having a vertical or horizontal metallic blade, the pole saw having a dual button stop that couples into the translation lock at the motor distal end, the pole saw shaft having a longer or shorter shaft casing, the brushcutter having quick means to clear smaller brush for the pole saw to maintain a stable footing when cutting thicker vertical or lateral brush, the power control handle longitudinal grip and Y handle lateral grip or the like may be further balanced with an auxiliary vertical harness, the yard tool attachments having means to facilitate generic handles, the yard tool attachments having means to couple generic shaft links, the yard tool attachments having means to be driven by generic drive shafts, the yard tool attachments having means to be stabilized by generic drive shaft casings, the yard tool attachments having means to be driven by generic motors that further meet high EPA standards, and

In accordance with a preferred embodiment of the invention, there is disclosed a process for A power tool for completing yard work a power source, the power source having a motor, the motor having a fuel tank or the like, a string trimmer yard tool attachment, the string trimmer having a shaft, the string trimmer having a drive shaft, the string trimmer having a Y handle, the string trimmer having a lawn cutting guard that substantially aligns with a lawn surface at all times of operation, the string trimmer having a button stop that connects the shaft to a translation and rotation lock at the motor distal end, the button stop engages a three-way bayonet, the shaft having a longer or shorter shaft casing, the string trimmer having an orthogonal isometry yard tool operating framework, the operating framework having longitudinal, lateral and vertical tool working planes, the tool working planes having identical yard tool transport routes, the tool working planes aligning parallel to a transport route of the main yard tool, the horizontal tool plane pivotal motion is parallel to the yard tool transport route, a power control handle, the power control handle having a longitudinal grip, the power control handle mounts to the motor casing, the power control handle having an lower aperture, the lower aperture having means for an index finger to compress the button stop for releasing the shaft at the motor distal end, the power control handle having ribs, the ribs are slightly compressed onto the shaft, the power control handle having tracks, the translation and rotational locks strengthen the shaft, the translation button stop and bayonet rotation lock maintain the string trimmer in a set operating framework when the rotation lock is released, the power control handle having a translation lock, the power control handle having a shaft release button, the power control handle having the main rotational lock at a frontal end and the translation lock tucked away for safe keeping, the motor mounts within a motor casing, the motor casing having an arm rest, the shaft casing can be extended into the motor casing, the shaft casing extension protects a plurality of stowed shafts, the arm rest having a lever to lift yard tools, the arm rest having means to help stabilize lateral yard tool motion, the arm rest having means to help stabilize vertical yard tool motion, the arm rest having means to help stabilize longitudinal yard tool motion, the arm rest having means to lift the yard tool as the fuel tank empties, the arm rest having means for right or left forearm use, the arm rest having means to assist with twelve or more different hand-arm muscle exercises, the string trimmer head having a debris brush, the debris brush having means to stabilize the yard tool, the debris brush made up of fine bristles, the debris brush having means to strengthen rotating string line filament outer ring tips, the debris brush having means to cool rotating string line filament spools, the debris brush having means to be replaced when worm, the debris brush having means to be clean the string trimmer head when rotated, the shaft having either a single or a dual button stop connected at the shaft motor end, the shaft having means to connect to compress onto a plurality of yard tool attachments, the shaft having means to have a plurality of segment lengths, the tool working planes aligning parallel to a transport route of yard tool attachments, the ribs having means for suspending a power cable support, the ribs having means for suspending a power wire, the ribs having means for dynamic reduction, the wand having means to be raised by the arm lever, the Y handle having a horizontal working plane grip and left and right vertical working plane grips, the Y handle having means to congruently align with optimal horizontal and vertical working planes, the Y handle having a yoke, the yoke having means to switch in an opposite direction, the Y handle having a plurality of lateral grip holding positions, the drive shaft rotated on a three-dimensional longitudinal, vertical and lateral axis, the drive shaft translated on the working plane, the drive shaft having means to be driven on a center of rotational symmetry, the drive shaft having means to be directed on a center of gravity, the drive shaft having means to be driven on a transport route, the drive shaft having means to maintain idle speed on the transport route, the drive shaft having means to be driven at substantially equal load at wide open throttle with auxiliary yard tool attachments, the drive shaft having means to drive the yard tool attachments at the shaft yard work distal end, the drive shaft having means to be driven by the motor at an opposite distal end of the shaft, the string trimmer may or may not have a transmission at the yard work distal end, the lawn cutting guard having aerodynamic guides, the power control handle and lateral Y handle having substantial balance, the power control handle and Y handle having combined torque to rotate yard tools attachments, interchanging of yard tool attachments without the need of interchanging handles the shaft, interchanging of yard tool attachments without the need of interchanging tools on the shaft, an auxiliary blower yard tool attachment that is operated between wide or narrow air discharge, the blower having the Y handle or the like for quick wand working planes that are linked to the motor, the auxiliary blower having means for the arm rest to be worked as a wand, the wand helps to control airflow disturbances, the blower having a shaft, the blower having a drive shaft, the blower may or may not have a wheel having, the blower having about a six inch fan mounted within a blower guard, the blower having a button stop that connects the shaft to the translation and rotation lock at the motor distal end, the blower shaft having a longer or a shorter shaft casing, the blower having means for a downward split vortex to maneuver debris in a horizontal working plane while keeping it mostly at ground level, the blower having means to be stabilized by the longitudinal arm lever, an auxiliary lawn edger tool yard tool attachment that is substantially operated in a vertical working plane, the edger having a shaft, the edger having a drive shaft, the edger having a transmission that drives the hedge trimmer, the edger having a wheel or the like, the wheel having means to help stabilize the edger, the edger having a V handle or the like, the V handle having means to hold the edging tool working plane in vertical working plane at all times of operation, the edger having a vertical metallic blade, the edger having a vertical and horizontal metallic cutting guard that significantly aligns to a lawn surface with aerodynamic guides, the edger having a dual-button stop that connects the shaft to the translation and rotation lock at the motor distal end, the edger shaft having a longer or a shorter shaft casing, the edger having means to maintain a vertical working plane at all times of operation, the edger having means to be stabilized by the longitudinal arm lever, an auxiliary brushcutter yard tool attachment that substantially operated in a horizontal working plane, the brushcutter having a shaft, the brushcutter having a drive shaft, the brushcutter having a transmission to create more torque with slower tool speed, the brushcutter having a J or bull horn handle, the J handle having a pair of lateral and overhand grips, the lateral grip having means to leverage the brushcutter with a strong claw or thumb grip, the brushcutter having a horizontal metallic blade, the brushcutter having a horizontal and vertical metallic cutting guard that significantly aligns to a lawn surface with aerodynamic guides, the brushcutter having a dual button stop that couples into the translation lock at the motor distal end, the brushcutter shaft having a longer or shorter shaft casing, the brushcutter having means to maintain a horizontal working plane link to the motor, the brushcutter having means to be stabilized by the longitudinal arm lever, an auxiliary hedge trimmer yard tool attachment that substantially operates in a two-hundred seventy five degree longitudinal radius, the hedge trimmer having a shaft, the hedge trimmer having a drive shaft, the hedge trimmer having a transmission to create more torque with slower tool speed, the hedge trimmer having a Y handle, the hedge trimmer Y handle having three grips, the grips having means to sculpt plants into round or platonic patterns, the hedge trimmer having a dual metallic blade, the hedge trimmer having a three-hundred sixty five degree cutting and debris guard, the hedge trimmer Y handle provide a second three-hundred sixty degree cutting guard, the hedge trimmer having a dual button stop that couples into the translation lock at the motor distal end, the hedge trimmer shaft having a longer or shorter shaft casing, the hedge trimmer having means to maintain the same power control handle grip for a third three-hundred sixty degree cutting guard, the hedge trimmer having means to be stabilized by the longitudinal arm lever, an auxiliary pole saw yard tool attachment that substantially operated in a vertical working plane, the pole saw having a shaft, the pole saw having a drive shaft, the pole saw having a pole handle, the pole saw having a vertical or horizontal metallic blade, the pole saw having a dual button stop that couples into the translation lock at the motor distal end, the pole saw shaft having a longer or shorter shaft casing, the brushcutter having quick means to clear smaller brush for the pole saw to maintain a stable footing when cutting thicker vertical or lateral brush, the power control handle longitudinal grip and Y handle lateral grip or the like may be further balanced with an auxiliary vertical harness, the yard tool attachments having means to facilitate generic handles, the yard tool attachments having means to couple generic shaft links, the yard tool attachments having means to be driven by generic drive shafts, the yard tool attachments having means to be stabilized by generic drive shaft casings, the yard tool attachments having means to be driven by generic motors that further meet high EPA standards.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of a yard tool illustrating a motor and power control handle that can be released from a lawn tool that generally consist of a string trimmer head, a shaft and a frontal control handle

FIG. 2a is a top view of the yard tool of FIG. 1 illustrating a shaft rotation lock in front of the power control handle and a partial cut away to reveal a translation lock that consists of a spring loaded button that snaps into a three-way bayonet

FIG. 2b is a top view section of the yard tool of FIG. 1 illustrating a Y handle with a plurality of hand grip exercise options

FIG. 3a is a bottom view of the yard tool of FIG. 1 illustrating the translation lock release at the motor end and the shaft rotation lock at the power control handle front end

FIG. 3b is a partial bottom section view of the yard tool of FIG. 1 illustrating the Y handle fastening method

FIG. 3c is a partial bottom section view of the yard tool of FIG. 1 illustrating the three-way bayonet lock and two gliding tracks for dual-button stops to glide through from the power control handle front rotational unlocked position

FIG. 4a is an isometric view of the yard tool of FIG. 1 illustrating an auxiliary yard tool for lawn edging

FIG. 4b is a partial bottom view of the yard tool of FIG. 4a illustrating a dual-button stop connected to a shaft

FIG. 5a is an isometric view of the yard tool of FIG. 1 illustrating an auxiliary yard tool attachment for brushcutting

FIG. 5b is a partial bottom view of the yard tool of FIG. 5a illustrating a dual-button stop connection to a shaft

FIG. 6a is an isometric view of the yard tool of FIG. 1 illustrating an auxiliary yard tool attachment for hedge trimming

FIG. 6b is a partial top view of the yard tool of FIG. 6a illustrating a button stop connection to a shaft

FIG. 7a is an isometric view of the yard tool of FIG. 1 illustrating an auxiliary yard tool attachment for tree pruning

FIG. 7b is a partial bottom view of the yard tool of FIG. 6a illustrating a dual-button stop connection to a shaft

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

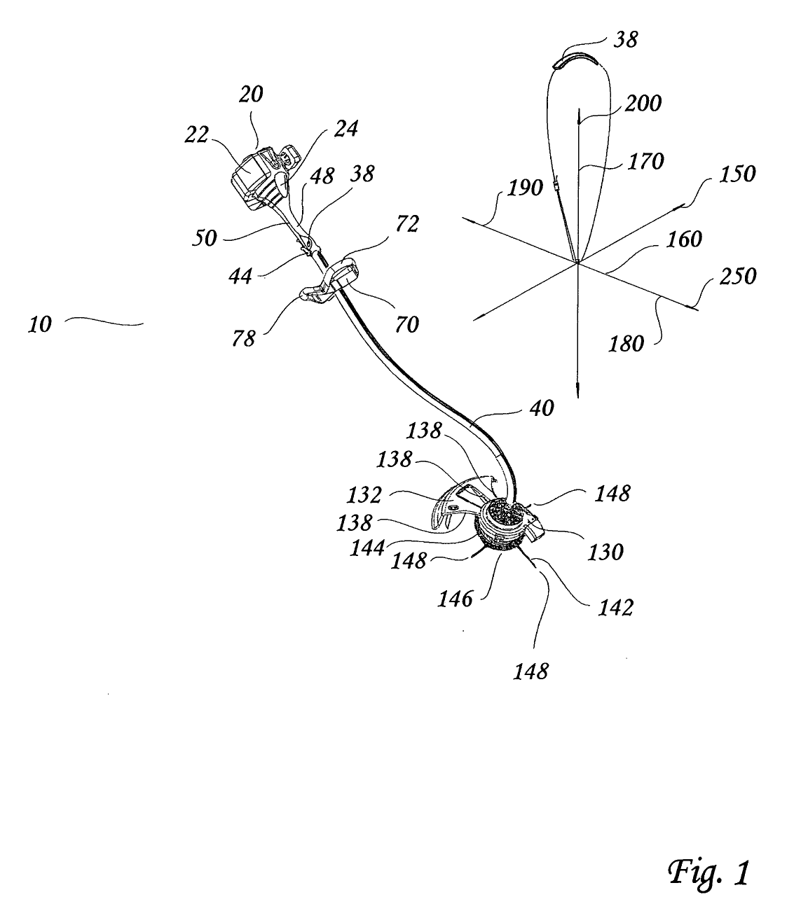

Referring to FIG. 1, A power tool for completing yard work, commonly referred to as a yard tool 10 including a power source 20 described as a fuel motor 22, but the motor 22 can be a different power source. The motor 20 having a fuel tank 16 with mean to drive a preferred string trimmer head 140 with a drive shaft 14 (not shown) on a horizontal 160 or vertical 170 working plane. The drive shaft 14 having means to be driven by the motor 22 at an opposite distal end 190 of a shaft 40 which can be rotated on a three-dimensional longitudinal 250, vertical 200 and lateral 150 axis. The drive shaft 14 has a center of rotational symmetry held substantially with a center of gravity along parallel working tool 180 and yard tool 10 transport 250 routes. The drive shaft 14 having means to maintain idle speed on the transport route 250 or providing substantially equal load at wide open throttle to drive auxiliary yard tool 10 attachment at a shaft 40 yard work distal end. The string trimmer 140 attachment consisting of a spool of string line filament 142, a fine bristle debris brush 144 that is replaceable when worn, that also cools the string line filament 142 as well as cleans the string trimmer head 140 and is a stabilizer to strengthen the string trimmer filament 142 outer ring tips 146, a supplementary shaft 40 that comes in only one segment length for each yard tool 10 attachment and a complimentary frontal Y handle 70 or the like with a yoke can be switched in opposite directions of the longitudinal 250 axis. The motor 22 will drive other yard tool 10 attachments; such as, a blower 130 or the like which further fits and assembles onto a supplementary shaft 40 and a complimentary Y handle 70 or the like. The string trimmer 140 attachment has a lawn cutting guard 132 with aerodynamic guides 138 that substantially aligns with a lawn surface at all times of operation. The string trimmer 140 may or may not have a transmission at the yard work 180 distal end.

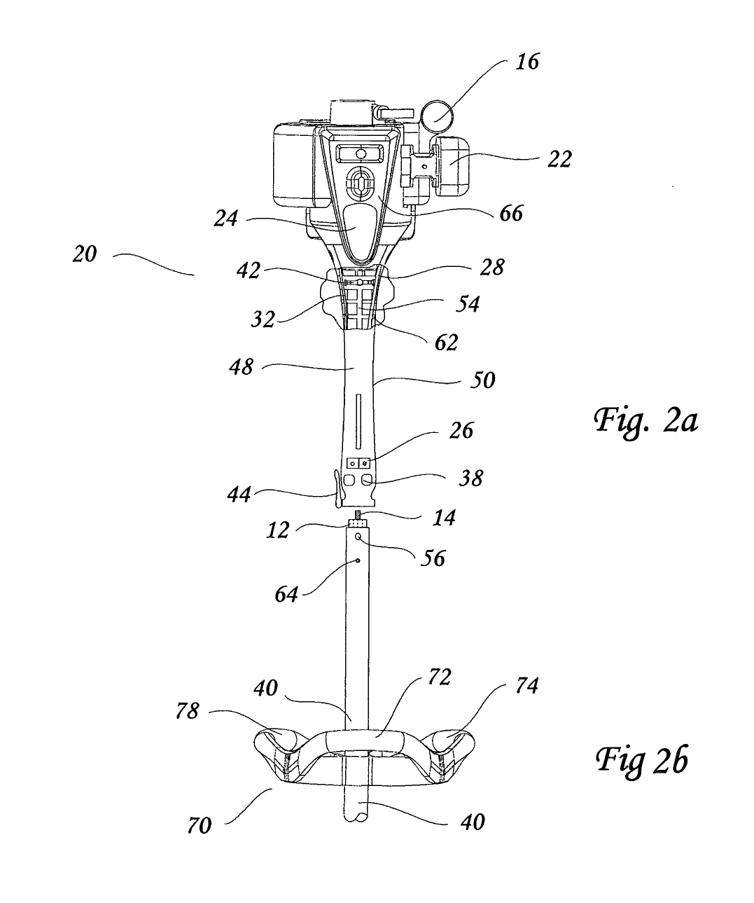

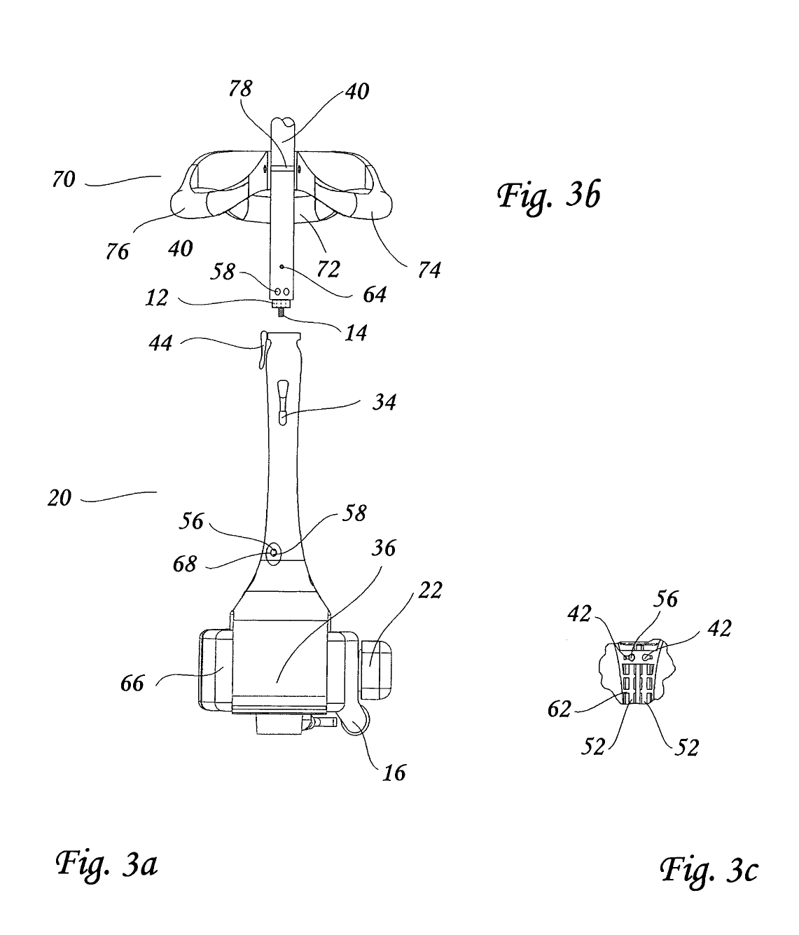

Referring to FIG. 1-3c, the string trimmer 140 attachment having a button stop 56 that connects the motor 22 to a supplementary shaft 40 with a three-way bayonet, that is, a translation 42 lock and a rotation 44 lock at the motor 22 distal end. The button stop 56 will rotate between the three bayonet stops without translating away from the motor 22 as shown by the top view cut out of FIG. 2a and the bottom cross section of FIG. 3c. A supplementary shaft 40 can have a longer or shorter casing 12. The casing 12 extension protects a plurality of stowed supplementary shafts 40. The translation 42 lock and the button 56 stop permit +/−one-hundred thirty five degree rotation of a supplementary shaft 40, the power source 20, the motor 22, the Y handle 70 or the like, the fuel tank 16 and a power control handle 50 after the rotation 44 lock is released. Rotation about the translation 42 lock by a supplementary shaft 40 provides a congruent lateral 150, vertical 200 and longitudinal 250 orthogonal isometry horizontal 160 or vertical 170 working planes. The translation 42 lock and the dual-button 58 stop will not allow rotation of the supplementary shaft 40, the power source 20, the motor 22, the Y handle 70 or the like, the fuel tank 16 and a power control handle 50 when the rotation 44 lock is tightly fastened or compressed. Therefore, the yard tool 10 attachments can either be locked into a single dual-button stop 56 horizontal 160 or vertical 170 working plane or rotate between the three-way translation 42 lock horizontal 160 or vertical 170 working planes having identical transport routes 250. The horizontal 160 or vertical 170 working planes are further aligning parallel to the transport route 250 of the main string trimmer 140 yard tool 10. When the yard tool 10 is in a lawn trimming position, that is, a horizontal working plane 160 the yard tool 10 pivotal motion is parallel to the yard tool 10 transport route 250. It is important to note that a longer casing 12 prevents a supplementary shaft 40 from damage while being stowed.

Still referring to FIG. 1-3c, the power control handle 50 has a longitudinal grip 48 that is can be held by a right or left hand. The power control handle 50 mounts to the motor casing 66 to keep the power source 20 generally in an upright working position. The power control handle has a lower aperture as a release button 68 location that is tucked away for safe keeping with means for an index finger to compress either a button 56 or a 58 dual-button stop for releasing the supplementary shaft 40 at the motor 22 distal end.

Referring to FIG. 3c, the power control handle having dynamic reduction ribs 62 that compress slightly onto a supplementary shaft 40. There is one upper and two lower tracks 54 within the power control handle 50 that permit a button 56 or dual-button 58 to glide in and out of a translation lock 42 position. The power control handle 50 ribs 62 provides suspension or support for a power cable 28 and on/off switch wire 26 whereas the tracks 54 help to suspend the dual-button 58 and button 56 stops. The translation 42 lock and the frontal main rotational 44 lock are strategically located to strengthen a plurality of supplementary shafts 40 that hold the yard tool 10 assembly together. The string trimmer head 140 attachment maintains set operating framework when the rotation lock 44 is released. The power control handle 50 and Y handle 70 having combined torque to rotate or for interchanging yard tool 10 attachments without the need of interchanging handles on the shaft.

Now referring to FIG. 1 and FIG. 2a, the power control handle 50 and lateral Y handle 70 having substantial balance to maintain the motor casing 66 arm rest 24 in substantial equilibrium. The arm rest 24 acts as a lever to raise the string trimmer head 140 or convert auxiliary yard tool 10 attachments like the blower 130 into a wand when operating the yard tool 10 in a vertical 170 working plane. It is important to note that when the yard tool 10 is meeting resistance in a horizontal working plane 160 the arm rest 24 helps to stabilize the lateral 150, longitudinal 200 and vertical 250 tool motion or more hidden energy transfer which further prevents user fatigue and vegetation from being scalped by operative string trimmer heads 140. It is further important to note that the power source 20 fuel tank empties its weight in proportion to the yard tool 10 use which allows an operator to get a feel for how much to raise or lower the arm rest 24 lever. In addition, the arm rest 24 can be occupied for right or left forearm use and encourages users to flex their arms into a more stable position. The plurality of Y handle 70 or the like overhand and lateral horizontal trimming 72 or left 76 and right 78 edging grips including the right and left handed power control handle 50 longitudinal grips 48 and arm rest 24 will assist with twelve or more different hand-arm muscle exercises. The Y handle 70 or the like adjusts along a supplementary shaft longitudinal axis 250 so that the arm rest 24 is a good fit. The Y handle may or may not adjust along the yard tool lateral 150 and vertical 200 axes.

Still referring to FIG. 1, the auxiliary blower 130 yard tool 10 that is mounted to a supplementary shaft 40 containing a drive shaft 14 (not shown) to drive a six inch fan within a guard 132 which may or may not have a wheel (not shown) mount that can be operated between wide 160 or narrow 170 air discharge working planes. The arm rest 24 can convert the supplementary shaft 40 into a blower 130 wand to be worked and stabilized along horizontal 160 and vertical 170 working planes when linked to the motor 22. The wand helps to control airflow disturbances. The blower 130 having a button stop that connects the shaft to the translation and rotation lock at the motor distal end which may have a longer or a shorter shaft casing 12 (not shown.) The blower 130 having means for a downward split vortex to maneuver yard waste 10 in a horizontal 160 working plane while keeping debris mostly at a ground level with a vertical 170 working plane.

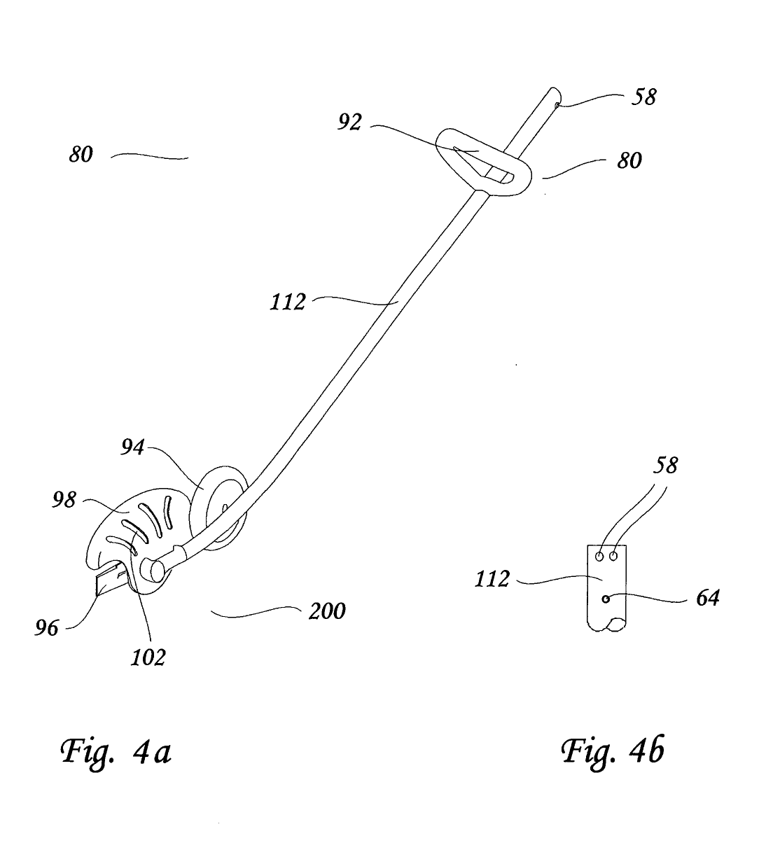

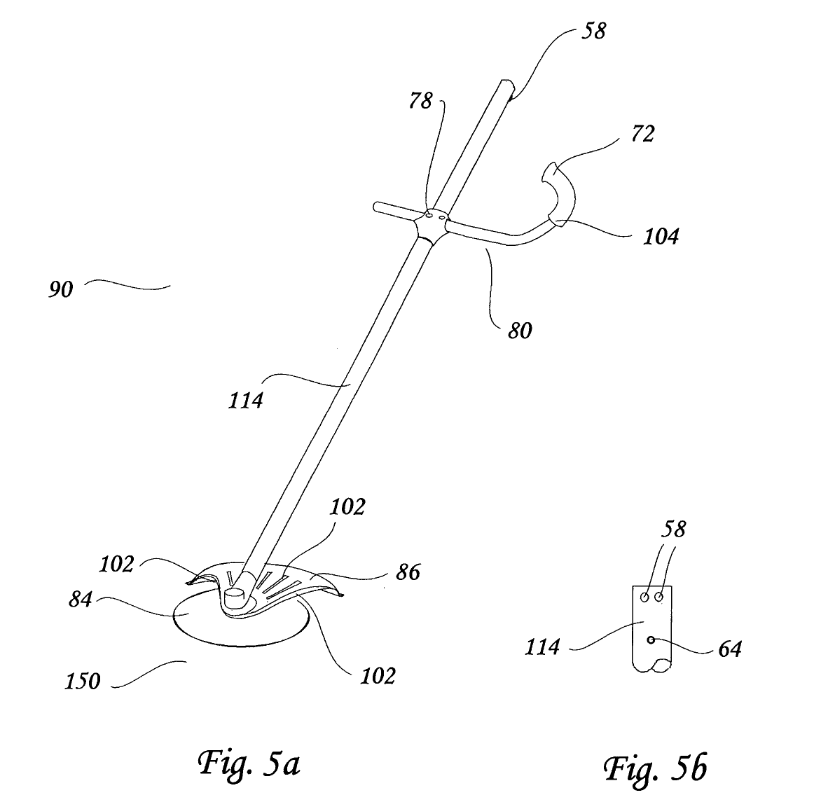

Referring to FIG. 4a-4b, FIG. 3a-3c and FIG. 1, the yard tool 10 string trimmer head 140 attachment can be released from the motor 22 so that a ready and able auxiliary lawn edger 80 attachment including a drive shaft 14 (not shown), a supplementary shaft 112 with transmission to drive the edger at a slower speed with higher torque, a complimentary V handle 92 can be substantially locked into a vertical 200 working plane at all times of operation by a dual button stop 58 as shown in FIG. 5b, a wheel 94 or the like for ground support and to help stabilize the edger 80, a vertical metallic blade and a vertical and horizontal metallic cutting guard 98 that significantly aligns to a lawn surface with aerodynamic guides 102. The edger having a dual-button stop that connects by a riot 64 to the shaft 80 and assembles to the translation 42 and rotation 44 lock at the motor distal end as shown in FIG. 3c. The edger 80 shaft 112 having a longer or a shorter shaft casing (not shown) to maintain a vertical 170 working plane at all times of operation. The edger 80 having means to be stabilized by the longitudinal arm rest 24 lever when having to raise the yard tool 10 onto elevated curbs.

Referring to FIG. 5a-5b, FIG. 3a-3c and FIG. 1, the yard tool 10 string trimmer head 140 attachment can be released from the motor 22 so that a ready and able auxiliary brushcutter 90 attachment including a drive shaft 14 (not shown), a supplementary shaft 114 with transmission to drive the brushcutter at a slower speed with higher torque, a complimentary J or bull-horn handle 104 with a light-duty overhand 72 grip and heavy-duty lateral 88 claw or thumb grip that can be exercised in about five minute intervals. The brushcutter 90 attachment having a horizontal metallic blade 84 and a horizontal and vertical metallic cutting guard 86 that significantly aligns to a lawn surface with aerodynamic guides 102 that substantially couples from rotation 42 lock to the translation 42 lock at the motor 22 distal end so that the brushcutter 90 attachment is locked into a horizontal 160 working plane at all times of operation by a dual-button stop 58. The brushcutter 90 shaft 114 having a longer or shorter shaft casing 12 (not shown.) The brushcutter 90 having means to maintain a horizontal 160 working plane link to the motor 22 which can be further stabilized from scalping yard vegetation by the longitudinal arm rest 24 lever.

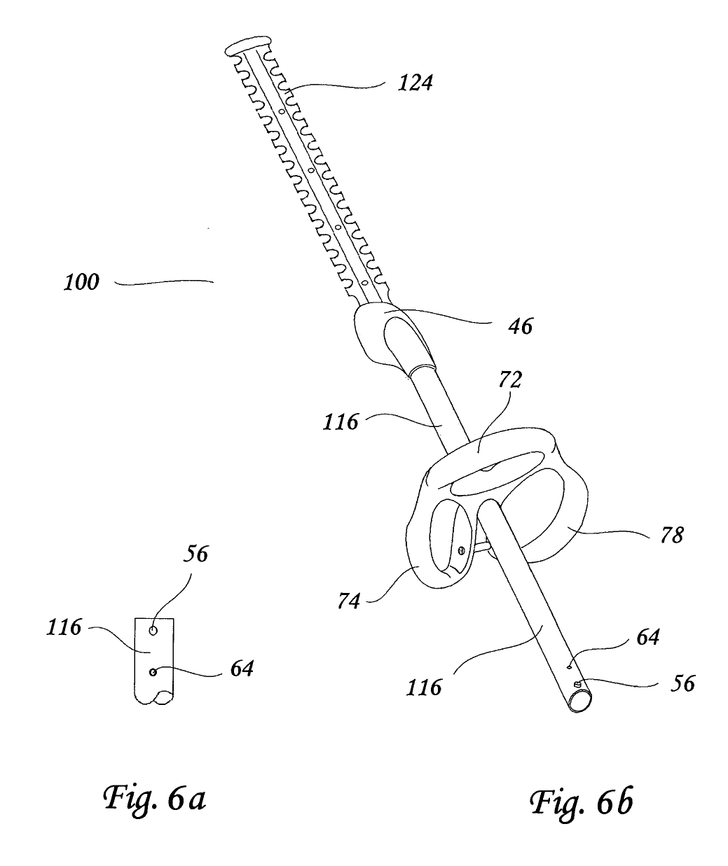

Referring to FIG. 6a-6b, FIG. 2a and FIG. 1, the yard tool 10 string trimmer head 140 attachment can be released from the motor 22 so that a ready and able auxiliary hedge trimmer 100 attachment including a drive shaft 14 (not shown), a supplementary shaft 116 with transmission 46 to drive the hedge trimmer 100 at a slower speed with higher torque, a complimentary Y handle or the like 70 providing two-hundred and seventy degrees of symmetrical rotation with three grips to sculpt plants into round or platonic patterns or figures. The hedge trimmer 100 shaft 116 has a balanced segment length that will minimize pivoting along a vertical axis 200 when the hedge trimmer 100 happens to be destabilized. The shaft 116 couples to the motor 22 from rotation 42 lock to the translation 42 lock. It is important to note that the Y handle 70 is a symmetrical guard that should be held with a frontal hand grip at all times of operation. Accordingly, a user can adjust the metallic blade while the power control handle remains in an identical upright position and the hedge trimmer 100 metallic blade 124 is stopped which appears to be safer than current power tool methods where users have to reach towards heavy, sharp blades to make blade adjustments or flip the motor and both control handles on end. It is further important to note that the radial cutting framework permits rounding of plants at ground level which eliminates the need to pull up on plants or repeated bending or leaning and the button 64 is a guide that discourages the hedge trimmer 100 from trimming into plant trunks. The hedge trimmer 100 attachment having a dual or single metallic blade 124 that substantially operates on a horizontal 160 and vertical 170 working plane. The hedge trimmer 100 having a longer or shorter shaft casing 12 (not shown) and a transmission 46 to create more metallic blade 124 torque with slower tool speed. The hedge trimmer 100 arm rest 24 providing stability when pivoting the lawn tool 10 in a vertical 170 or horizontal working plane.

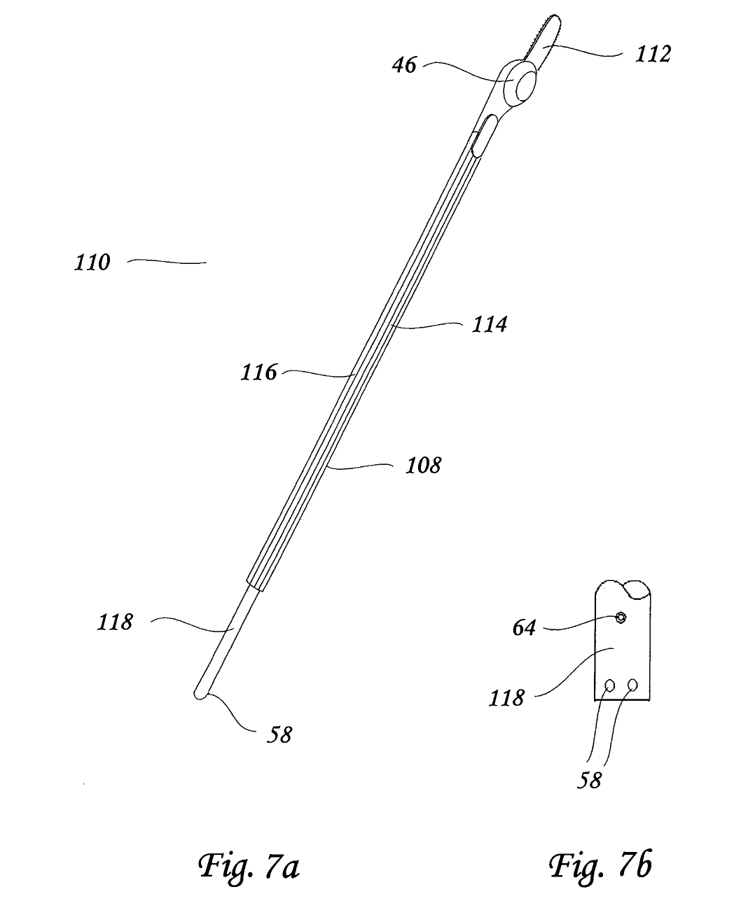

Referring to FIG. 7 a-7b, FIG. 5a and FIG. 1, the yard tool 10 auxiliary blower 130 yard tool 10 the yard tool 10 string trimmer head 140 attachment can be released from the motor 22 so that a ready and able auxiliary pole saw 110 with a supplementary shaft 118 containing an elongated drive shaft 14 (not shown) within a pole handle 108 with right 114 and left 116 grips to translate a metallic saw blade 112 in a vertical 200 axis position for general rotation of the metallic blade 112 in a vertical 170 working plane. The arm rest 24 doesn't interfere with the pole saw 110 vertical working plane 170. The dual button lock 58 locks the motor 22 and pole saw 110 into the same vertical 170 or horizontal working planes. The pole saw 110 may have a longer or shorter shaft casing 12. It is important to note that the yard tool 10 brushcutter 90 attachment of FIG. 5a has quick means to clear smaller brush or tree saplings for the pole saw 110 to maintain a stable footing when cutting through thicker vertical 170 or lateral 160 brush;

Referring finally back to FIG. 1, the yard tool 10 provides a process that can be further operated by the motor 22 with an auxiliary harness 210. The harness provides vertical 200 support at the equilibrium point 38 with longitudinal 250 support coming from the power control handle 50, lateral support coming from the frontal Y handle 70 and secondary arm rest 24 lever support generally finishing up to the remaining yard tool 10 support. The Triplex handle 70, although pleasing, playable and protective of people and property can be substituted with other reasonable means. It is important to note that the yard tool 10 bow shaft 40 of FIG. 1 can be straight or with other bends. The yard tool 10 attachments can be driven by the motor 22 or generic motors that further meet high EPA standards.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A power tool for completing yard work comprising:
a power source;
the power source having a motor;
the motor having a fuel tank or the like;
a string trimmer yard tool attachment;
the string trimmer having a shaft;
the string trimmer having a drive shaft;
the string trimmer having a Y handle;
the string trimmer having a lawn cutting guard that substantially aligns with a lawn surface at all times of operation;
the string trimmer having a button stop that connects the shaft to a translation and rotation lock at the motor distal end;
the button stop engages a three-way bayonet;
the shaft having a longer or shorter shaft casing;
the string trimmer having an orthogonal isometry yard tool operating framework;
the operating framework having longitudinal, lateral and vertical tool working planes;
the tool working planes having identical yard tool transport routes;
the tool working planes aligning parallel to a transport route of the main yard tool;
the horizontal tool plane pivotal motion is parallel to the yard tool transport route;
a power control handle;
the power control handle having a longitudinal grip;
the power control handle mounts to the motor casing;
the power control handle having an lower aperture;
the lower aperture having means for an index finger to compress the button stop for releasing the shaft at the motor distal end;
the power control handle having ribs;
the ribs are slightly compressed onto the shaft;
the power control handle having tracks;
the translation and rotational locks strengthen the shaft;
the translation button stop and bayonet rotation lock maintain the string trimmer in a set operating framework when the rotation lock is released;
the power control handle having a translation lock;
the power control handle having a shaft release button;
the power control handle having the main rotational lock at a frontal end and the translation lock tucked away for safe keeping;
the motor mounts within a motor casing;
the motor casing having an arm rest;
the shaft casing can be extended into the motor casing;
the shaft casing extension protects a plurality of stowed shafts;
the arm rest having a lever to lift yard tools;
the arm rest having means to help stabilize lateral yard tool motion;
the arm rest having means to help stabilize vertical yard tool motion;
the arm rest having means to help stabilize longitudinal yard tool motion;
the arm rest having means to lift the yard tool as the fuel tank empties;
the arm rest having means for right or left forearm use;
the arm rest having means to assist with twelve or more different hand-arm muscle exercises;
the string trimmer head having a debris brush;
the debris brush having means to stabilize the yard tool;
the debris brush made up of fine bristles;
the debris brush having means to strengthen rotating string line filament outer ring tips;
the debris brush having means to cool rotating string line filament spools;
the debris brush having means to be replaced when worn;
the debris brush having means to clean the string trimmer head when rotated;
the shaft having either a single or a dual button stop connected at the shaft motor end;
the shaft having means to connect to compress onto a plurality of yard tool attachments;
the shaft having means to have a plurality of segment lengths;
the tool working planes aligning parallel to a transport route of yard tool attachments;
the ribs having means for suspending a power cable support;
the ribs having means for suspending a power wire;
the ribs having means for dynamic reduction;
the wand having means to be raised by the arm lever;
the Y handle having a horizontal working plane grip and left and right vertical working plane grips;
the Y handle having means to congruently align with optimal horizontal and vertical working planes;
the Y handle having a yoke;
the yoke having means to switch in an opposite direction;
the Y handle having a plurality of lateral grip holding positions;
the drive shaft rotated on a three-dimensional longitudinal, vertical and lateral axis;
the drive shaft translated on the working plane;
the drive shaft having means to be driven on a center of rotational symmetry;
the drive shaft having means to be directed on a center of gravity;
the drive shaft having means to be driven on a transport route;
the drive shaft having means to maintain idle speed on the transport route;
the drive shaft having means to be driven at substantially equal load at wide open throttle with auxiliary yard tool attachments;
the drive shaft having means to drive the yard tool attachments at the shaft yard work distal end;
the drive shaft having means to be driven by the motor at an opposite distal end of the shaft;
the string trimmer may or may not have a transmission at the yard work distal end;
the lawn cutting guard having aerodynamic guides;
the power control handle and lateral Y handle having substantial balance;
the power control handle and Y handle having combined torque to rotate yard tools attachments;
interchanging of yard tool attachments without the need of interchanging handles the shaft;
interchanging of yard tool attachments without the need of interchanging tools on the shaft;
an auxiliary blower yard tool attachment that is operated between wide or narrow air discharge;
the blower having the Y handle or the like for quick wand working planes that are linked to the motor;
the auxiliary blower having means for the arm rest to be worked as a wand;
the wand helps to control airflow disturbances;
the blower having a shaft;
the blower having a drive shaft;
the blower may or may not have a wheel having;
the blower having about a six inch fan mounted within a blower guard;
the blower having a button stop that connects the shaft to the translation and rotation lock at the motor distal end;
the blower shaft having a longer or a shorter shaft casing;
the blower having means for a downward split vortex to maneuver debris in a horizontal working plane while keeping it mostly at ground level;
the blower having means to be stabilized by the longitudinal arm lever;
an auxiliary lawn edger tool yard tool attachment that is substantially operated in a vertical working plane;
the edger having a shaft;
the edger having a drive shaft;
the edger having a transmission having means to drive at a slower speed with higher torque;
the edger having a wheel or the like;
the wheel having means to help stabilize the edger;
the edger having a V handle or the like;
the V handle having means to hold the edging tool working plane in vertical working plane at all times of operation;
the edger having a vertical metallic blade;
the edger having a vertical and horizontal metallic cutting guard that significantly aligns to a lawn surface with aerodynamic guides;
the edger having a dual-button stop that connects the shaft to the translation and rotation lock at the motor distal end;
the edger shaft having a longer or a shorter shaft casing;
the edger having means to maintain a vertical working plane at all times of operation;
the edger having means to be stabilized by the longitudinal arm lever;
an auxiliary brushcutter yard tool attachment that substantially operated in a horizontal working plane;
the brushcutter having a shaft;
the brushcutter having a drive shaft;
the brushcutter having a transmission to create more torque with slower tool speed;
the brushcutter having a J or bull horn handle;
the J handle having a pair of lateral and overhand grips;
the lateral grip having means to leverage the brushcutter with a strong claw or thumb grip;
the brushcutter having a horizontal metallic blade;
the brushcutter having a horizontal and vertical metallic cutting guard that significantly aligns to a lawn surface with aerodynamic guides;
the brushcutter having a dual button stop that couples into the translation lock at the motor distal end;
the brushcutter shaft having a longer or shorter shaft casing;
the brushcutter having means to maintain a horizontal working plane link to the motor;
the brushcutter having means to be stabilized by the longitudinal arm lever;
an auxiliary hedge trimmer yard tool attachment that substantially operates in a two-hundred seventy five degree longitudinal radius;
the hedge trimmer having a shaft;
the hedge trimmer having a drive shaft;
the hedge trimmer having a transmission to create more torque with slower tool speed;
the hedge trimmer having a Y handle;
the hedge trimmer Y handle having three grips;
the grips having means to sculpt plants into round or platonic patterns;
the hedge trimmer having a dual or one sided metallic blade;
the hedge trimmer having a three-hundred sixty five degree cutting and debris guard;
the hedge trimmer Y handle provide a second three-hundred sixty degree cutting guard;
the hedge trimmer having a dual button stop that couples into the translation lock at the motor distal end;
the hedge trimmer shaft having a longer or shorter shaft casing;
the hedge trimmer having means to maintain the same power control handle grip for a third three-hundred sixty degree cutting guard;
the hedge trimmer having means to be stabilized by the longitudinal arm lever;
an auxiliary pole saw yard tool attachment that substantially operated in a vertical working plane;
the pole saw having a shaft;
the pole saw having a drive shaft;
the pole saw having a pole handle;
the pole saw having a vertical or horizontal metallic blade;
the pole saw having a dual button stop that couples into the translation lock at the motor distal end;
the pole saw shaft having a longer or shorter shaft casing;
the brushcutter having quick means to clear smaller brush for the pole saw to maintain a stable footing when cutting thicker vertical or lateral brush;
the power control handle longitudinal grip and Y handle lateral grip or the like may be further balanced with an auxiliary vertical harness;
the yard tool attachments having means to facilitate generic handles;
the yard tool attachments having means to couple generic shaft links;
the yard tool attachments having means to be driven by generic drive shafts;
the yard tool attachments having means to be stabilized by generic drive shaft casings;
the yard tool attachments having means to be driven by generic motors that further meet high EPA standards;
; and

2. A process for A power tool for completing yard work a power source;
the power source having a motor;
the motor having a fuel tank or the like;
a string trimmer yard tool attachment;
the string trimmer having a shaft;
the string trimmer having a drive shaft;
the string trimmer having a Y handle;
the string trimmer having a lawn cutting guard that substantially aligns with a lawn surface at all times of operation;
the string trimmer having a button stop that connects the shaft to a translation and rotation lock at the motor distal end;
the button stop engages a three-way bayonet;
the shaft having a longer or shorter shaft casing;
the string trimmer having an orthogonal isometry yard tool operating framework;
the operating framework having longitudinal, lateral and vertical tool working planes;
the tool working planes having identical yard tool transport routes;
the tool working planes aligning parallel to a transport route of the main yard tool;
the horizontal tool plane pivotal motion is parallel to the yard tool transport route;
a power control handle;
the power control handle having a longitudinal grip;
the power control handle mounts to the motor casing;
the power control handle having an lower aperture;
the lower aperture having means for an index finger to compress the button stop for releasing the shaft at the motor distal end;
the power control handle having ribs;
the ribs are slightly compressed onto the shaft;
the power control handle having tracks;
the translation and rotational locks strengthen the shaft;
the translation button stop and bayonet rotation lock maintain the string trimmer in a set operating framework when the rotation lock is released;
the power control handle having a translation lock;
the power control handle having a shaft release button;
the power control handle having the main rotational lock at a frontal end and the translation lock tucked away for safe keeping;
the motor mounts within a motor casing;
the motor casing having an arm rest;
the shaft casing can be extended into the motor casing;
the shaft casing extension protects a plurality of stowed shafts;
the arm rest having a lever to lift yard tools;
the arm rest having means to help stabilize lateral yard tool motion;
the arm rest having means to help stabilize vertical yard tool motion;
the arm rest having means to help stabilize longitudinal yard tool motion;
the arm rest having means to lift the yard tool as the fuel tank empties;
the arm rest having means for right or left forearm use;
the arm rest having means to assist with twelve or more different hand-arm muscle exercises;
the string trimmer head having a debris brush;
the debris brush having means to stabilize the yard tool;
the debris brush made up of fine bristles;
the debris brush having means to strengthen rotating string line filament outer ring tips;
the debris brush having means to cool rotating string line filament spools;
the debris brush having means to be replaced when worn;
the debris brush having means to clean the string trimmer head when rotated;
the shaft having either a single or a dual button stop connected at the shaft motor end;
the shaft having means to connect to compress onto a plurality of yard tool attachments;
the shaft having means to have a plurality of segment lengths;
the tool working planes aligning parallel to a transport route of yard tool attachments;
the ribs having means for suspending a power cable support;
the ribs having means for suspending a power wire;
the ribs having means for dynamic reduction;
the wand having means to be raised by the arm lever;
the Y handle having a horizontal working plane grip and left and right vertical working plane grips;
the Y handle having means to congruently align with optimal horizontal and vertical working planes;
the Y handle having a yoke;
the yoke having means to switch in an opposite direction;
the Y handle having a plurality of lateral grip holding positions;
the drive shaft rotated on a three-dimensional longitudinal, vertical and lateral axis;
the drive shaft translated on the working plane;
the drive shaft having means to be driven on a center of rotational symmetry;
the drive shaft having means to be directed on a center of gravity;
the drive shaft having means to be driven on a transport route;
the drive shaft having means to maintain idle speed on the transport route;
the drive shaft having means to be driven at substantially equal load at wide open throttle with auxiliary yard tool attachments;
the drive shaft having means to drive the yard tool attachments at the shaft yard work distal end;
the drive shaft having means to be driven by the motor at an opposite distal end of the shaft;
the string trimmer may or may not have a transmission at the yard work distal end;
the lawn cutting guard having aerodynamic guides;
the power control handle and lateral Y handle having substantial balance;
the power control handle and Y handle having combined torque to rotate yard tools attachments;
interchanging of yard tool attachments without the need of interchanging handles the shaft;
interchanging of yard tool attachments without the need of interchanging tools on the shaft;
an auxiliary blower yard tool attachment that is operated between wide or narrow air discharge;
the blower having the Y handle or the like for quick wand working planes that are linked to the motor;
the auxiliary blower having means for the arm rest to be worked as a wand;
the wand helps to control airflow disturbances;
the blower having a shaft;
the blower having a drive shaft;
the blower may or may not have a wheel having;
the blower having about a six inch fan mounted within a blower guard;
the blower having a button stop that connects the shaft to the translation and rotation lock at the motor distal end;
the blower shaft having a longer or a shorter shaft casing the blower having means for a downward split vortex to maneuver debris in a horizontal working plane while keeping it mostly at ground level;
the blower having means to be stabilized by the longitudinal arm lever;
an auxiliary lawn edger tool yard tool attachment that is substantially operated in a vertical working plane;
the edger having a shaft;
the edger having a drive shaft;
the edger having a transmission having means to drive at a slower speed with higher torque;
the edger having a wheel or the like;
the wheel having means to help stabilize the edger;
the edger having a V handle or the like;
the V handle having means to hold the edging tool working plane in vertical working plane at all times of operation;
the edger having a vertical metallic blade;
the edger having a vertical and horizontal metallic cutting guard that significantly aligns to a lawn surface with aerodynamic guides;
the edger having a dual-button stop that connects the shaft to the translation and rotation lock at the motor distal end;
the edger shaft having a longer or a shorter shaft casing;
the edger having means to maintain a vertical working plane at all times of operation;
the edger having means to be stabilized by the longitudinal arm lever;
an auxiliary brushcutter yard tool attachment that substantially operated in a horizontal working plane;
the brushcutter having a shaft;
the brushcutter having a drive shaft;
the brushcutter having a transmission to create more torque with slower tool speed;
the brushcutter having a J or bull horn handle;
the J handle having a pair of lateral and overhand grips;
the lateral grip having means to leverage the brushcutter with a strong claw or thumb grip;
the brushcutter having a horizontal metallic blade;
the brushcutter having a horizontal and vertical metallic cutting guard that significantly aligns to a lawn surface with aerodynamic guides;
the brushcutter having a dual button stop that couples into the translation lock at the motor distal end;
the brushcutter shaft having a longer or shorter shaft casing;
the brushcutter having means to maintain a horizontal working plane link to the motor;
the brushcutter having means to be stabilized by the longitudinal arm lever;
an auxiliary hedge trimmer yard tool attachment that substantially operates in a two-hundred seventy five degree longitudinal radius;
the hedge trimmer having a shaft;
the hedge trimmer having a drive shaft;
the hedge trimmer having a transmission to create more torque with slower tool speed;
the hedge trimmer having a Y handle;
the hedge trimmer Y handle having three grips;
the grips having means to sculpt plants into round or platonic patterns;
the hedge trimmer having a dual or one sided metallic blade;
the hedge trimmer having a three-hundred sixty five degree cutting and debris guard;
the hedge trimmer Y handle provide a second three-hundred sixty degree cutting guard;
the hedge trimmer having a dual button stop that couples into the translation lock at the motor distal end;
the hedge trimmer shaft having a longer or shorter shaft casing;
the hedge trimmer having means to maintain the same power control handle grip for a third three-hundred sixty degree cutting guard;
the hedge trimmer having means to be stabilized by the longitudinal arm lever;
an auxiliary pole saw yard tool attachment that substantially operated in a vertical working plane;
the pole saw having a shaft;
the pole saw having a drive shaft;
the pole saw having a pole handle;
the pole saw having a vertical or horizontal metallic blade;
the pole saw having a dual button stop that couples into the translation lock at the motor distal end;
the pole saw shaft having a longer or shorter shaft casing;
the brushcutter having quick means to clear smaller brush for the pole saw to maintain a stable footing when cutting thicker vertical or lateral brush;
the power control handle longitudinal grip and Y handle lateral grip or the like may be further balanced with an auxiliary vertical harness;
the yard tool attachments having means to facilitate generic handles;
the yard tool attachments having means to couple generic shaft links;
the yard tool attachments having means to be driven by generic drive shafts;
the yard tool attachments having means to be stabilized by generic drive shaft casings;
the yard tool attachments having means to be driven by generic motors that further meet high EPA standards.
